(19) United States
(12) Patent Application Publication
(10) Pub. No.: US 2023/0256669 A1
(43) Pub. Date: Aug. 17, 2023

(54) ADDITIVE MANUFACTURING METHODS USING REDUCED SUPPORT MATERIAL

(71) Applicant: Evolve Additive Solutions, Inc., Minnetonka, MN (US)

(72) Inventors: Zeiter Farah, Minneapolis, MN (US); J. Samuel Batchelder, Somers, NY (US); Manish Boorugu, Minneapolis, MN (US); Brian Mullen, Delano, MN (US); Alex J. Kossett, Minnetonka, MN (US)

(21) Appl. No.: 18/016,224

(22) PCT Filed: Jul. 15, 2021
(86) PCT No.: PCT/US2021/041797

§ 371 Date: Jan. 13, 2023

Related U.S. Application Data
(60) Provisional application No. 63/052,300, filed on Jul. 15, 2020.

(51) Int. Cl. B29C 64/147; B29C 64/223; B29C 64/40

(52) U.S. Cl. CPC B29C 64/147; B29C 64/223; B29C 64/40; B33Y 10/00

(57) ABSTRACT

Methods and systems for additive manufacturing are disclosed, the methods and systems comprising reducing the amount of support material used, by one or more methods, including inclusion of part material voxels and air voxels within the support regions, using a lattice of part material within support regions, printing one or more skin layers and boundary layers to support the part geometry and surface, and printing support layers in a drafted manner to reduce support material.

This application is being filed as a PCT International Patent application on Jul. 15, 2021, in the name of Evolve Additive Solutions, Inc., a U.S. national corporation, applicant for the designation of all countries, and Zeiter Farah, a U.S. Citizen, and J. Samuel Batchelder, a U.S. Citizen, and Manish Boorugu, a U.S. Citizen, and Brian Mullen, a U.S. Citizen, and Alex J. Kossett, a U.S. Citizen, inventors for the designation of all countries, and claims priority to U.S. Provisional Patent Application No. 63/052,300, filed Jul. 15, 2020, the contents of which are herein incorporated by reference in its entirety.

### FIELD

The present disclosure relates to additive manufacturing systems for building three-dimensional (3D) parts and support structures. In particular, the present disclosure relates to additive manufacturing systems and processes for building 3D parts and support structures using an imaging process, such as electrostatography, with reduced support material.

### BACKGROUND

Additive manufacturing systems are used to build 3D parts from digital representations of the 3D parts (e.g., STL format files) using one or more additive manufacturing techniques. Examples of commercially available additive manufacturing techniques include extrusion-based techniques, ink jetting, selective laser sintering, powder/binder jetting, electron-beam melting, and stereolithographic processes. For each of these techniques, the digital representation of the 3D part is initially sliced into multiple horizontal layers. For each sliced layer, a tool path is then generated, which provides instructions for the particular additive manufacturing system to form the given layer.

For example, in an extrusion-based additive manufacturing system, a 3D part or model may be printed from a digital representation of the 3D part in a layer-by-layer manner by extruding a flowable part material. The part material is extruded through an extrusion tip carried by a print head of the system, and is deposited as a sequence of roads on a substrate in an x-y plane. The extruded part material fuses to previously deposited part material, and solidifies upon a drop in temperature. The position of the print head relative to the substrate is then incremented along a z-axis (perpendicular to the x-y plane), and the process is then repeated to form a 3D part resembling the digital representation.

In fabricating 3D parts by depositing layers of a part material, supporting layers or structures are typically built underneath overhanging portions or in cavities of objects under construction, which are not supported by the part material itself. A support structure may be built utilizing the same deposition techniques by which the part material is deposited. The host computer generates additional geometry acting as a support structure for the overhanging or free-space segments of the 3D part being formed. Support material is then deposited from a second nozzle pursuant to the generated geometry during the printing process. The support material adheres to the modeling material during fabrication and is removable from the completed 3D part when the printing process is complete.

In addition to the aforementioned commercially available additive manufacturing techniques, a further additive manufacturing technique has emerged, where particles are first selectively deposited in an imaging process, forming a layer corresponding to a slice of the part to be made; the layers are bonded to each other, forming a part. This is a selective deposition process, in contrast to, for example, selective sintering, where the imaging and part formation happens simultaneously. The imaging step in a selective deposition process can be done using electrophotography. In two-dimensional (2D) printing, electrophotography (i.e., xerography) is a popular technology for creating 2D images on planar substrates, such as printing paper. Electrophotography systems include a conductive support drum coated with a photoconductive material layer, where latent electrostatic images are formed by charging and then image-wise exposing the photoconductive layer by an optical source. The latent electrostatic images are then moved to a electrostatographically developing station where toner is applied to charged areas of the photoconductive insulator to form visible images. The formed toner images are then transferred to substrates (e.g., printing paper) and affixed to the substrates with heat or pressure. This technique is often called a Selective Thermoplastic Electrophotographic Process (“STEP”) printing process. The STEP process typically deposits two materials: a part (or “model”) material and a support material. The part material is retained in the finished product, while the support material is removed, such as by dissolving with a solvent that does not dissolve the part material. In certain embodiments the support material is subsequently recovered and reused. Reducing the amount of support material used to produce a given part remains a desired objective when printing using STEP printing processes.

### SUMMARY

The present disclosure is directed, generally, to methods of practicing STEP printing processes so as to reduce the amount of support material that is used. Generally, such methods involve reducing the amount of support material and replacing it with material-free areas, such as by increasing non-printed “air” voxels. Thus, in some embodiments support voxels are replaced with air voxels, starting at the top surface of the bounding box defining the model (or part), and stopping at the first part voxel for each (x,y) location. The reductions in support material are made in a controlled manner to preserve the overall quality of the printed part.

In a further example embodiment, it is possible to replace some of the support material with part material, which can be desirable in implementations where the part material is less expensive than the support material, or where the part material is more readily reused than the support material. In such constructions a sparse lattice of part voxels replaces support voxels away from part surfaces for added strength and reduced cost. In such embodiments the part voxels are intermixed with support voxels, and optionally air voxels, to reduce cost while retaining performance and part quality of the printed part.

In a further example implementations, a sparse lattice of model material in the remaining support volume is used to reduce support flow and further reduce support consumption. In these implementations, a portion of the support material is replaced with part material in regions that do not form the finished part. The part material deposited into the support material is typically deposited in a manner that it does not significantly impede the removal of support material, and also does not have structural integrity that would prevent it removal after dissolving the support material.

Further, in some implementations it is possible to draft the support vertical walls outwards to the extent that the support material will tolerate shelving, in other words it is possible to have support layers extend outward as they are built upward, thereby reducing the total amount of support material that is used.

In all such constructions, particular care is generally given to the surface that will form the exterior of the finished part (i.e., the surface of the finished part). Thus, a “skin” of support material can be printed immediately adjacent to the part material within a part build bounding box, along then methods of reducing support material further away from the surface of the part. These methods retain part surface quality while reducing support material.

It will be appreciated that these various techniques can, and often are, combined together. For example, it is possible to create a skin of support material around the part surface, while also printing a lattice of part and support material away from the part surface. In the alternative, it is possible to use both a combination of part lattice and air voxels to reduce the amount of support material. Similarly, these techniques can be combined with drafting of the support layers (whether they be entirely support material, or support material combined with part material and/or air voxels).

In an embodiment, a method of printing a part in an additive manufacturing system is disclosed, the method including developing a layer of a part material through electrostatography, developing a layer of a support material through electrostatography, and stacking and bonding the layers of support material and the layers of part material to form a three-dimensional part, wherein the support material is configured to form a support skin around an upward-facing surface of the three-dimensional part A skin laminated with the part upward facing surface will have a thickness normal to the part surface. Since the surface is upward facing, the skin thickness along the surface normal will generally have a horizontal (x,y) and a vertical (z) component; in what follows we will characterize the skin thickness by this vertical component.

In an embodiment, the support skin has a thickness of 0.5 to 2.5 mm, alternatively from 0.25 to 5.0 mm; alternatively, from 0.1 mm to 5.0 mm In some implementations the normal skin thickness is from 1 to 2 layers thick, from 1 to 8 layers thick, from 1 to 6 layers thick, or from 1 to 4 layers thick. In some implementations the thickness is less than 20 layers thick, less than 15 layers thick, less than 10 layers thick, less than 8 layers thick, less than 6 layers thick, less than 4 layers thick, less than 3 layers thick, or less than 2 layers thick. In absolute thickness, the skin layer can optionally be 10 um or greater, 15 um or great, 20 um or greater, 30 um or greater, 40 um or greater, or 50 um or greater. In an embodiment, a boundary layer forms around the support skin, the bounding layer formed of part material.

In a typical prior brick build, a cuboid space is filled entirely, or nearly entirely, with non-air-voxels. In certain implementations of the present disclosure, the volume of support material in the completed assembly is less than 80% of the support volume required to solidly print the bounding box, alternatively less than 95 of the support volume required, alternatively less than 85 of the support volume required, alternatively less than 75 of the support volume required, alternatively less than 60 of the support volume required, or alternatively less than 50 of the support volume required,

In an embodiment, the boundary layer includes part material.

In an embodiment, the boundary layer has a thickness of 0.5 to 2.5 mm.

In an embodiment, the boundary layer forms a boundary to constrain the flow of the support material.

In an embodiment, the boundary layer is of sufficient strength to resist deformation of the support structure during printing of a layer of the part.

In an embodiment, the layer of support material includes a lattice of support voxels and a lattice of part material voxels.

In an embodiment, the part material voxels do not make contact with the three-dimensional part.

In an embodiment, wherein the layer of support material includes a lattice of support voxels and a lattice of air voxels.

In an embodiment, further can include, drafting the support vertical walls outwards as the layers increase in the z-axis.

In an embodiment, the porosity of support material increases in with distance from part material.

In an embodiment, a method of printing a part in an additive manufacturing system is disclosed. In an embodiment the method includes developing a layer of a part material through electrostatography and developing a layer of a support material through electrostatography, wherein the layer of support material includes a lower concentration of support material distal to the interface between the part material and support material.

In an embodiment, the process further can further include producing a support skin, wherein the support skin has a thickness of 0.5 to 2.5 mm.

In an embodiment, the process further can include forming a boundary layer around the support skin.

In an embodiment, the boundary layer includes of part material.

In an embodiment, the boundary layer has a thickness of 0.5 to 2.5 mm.

In an embodiment, the boundary layer forms a boundary to constrain the flow of the support material.

In an embodiment, the boundary layer is of sufficient strength to resist deformation of the support structure during printing of a layer of the part.

In an embodiment, the layer of support material includes a lattice of support voxels and a lattice of part material voxels.

In an embodiment, the part material voxels do not make contact with the three-dimensional part.

In an embodiment, the layer of support material includes a lattice of support voxels and a lattice of air voxels.

In an embodiment, the process can further include drafting the support vertical walls outwards as the layers increase in the z-axis.

In an embodiment, the porosity of support material increases in with distance from part material.

Directional orientations such as “above”, “below”, “top”, “bottom”, and the like are made with reference to a direction along a printing axis of a 3D part. In the embodiments in which the printing axis is a vertical z-axis, the layer-printing direction is the upward direction along the vertical z-axis. In these embodiments, the terms “above”, “below”, “top”, “bottom”, and the like are based on the vertical z-axis. However, in embodiments in which the layers of 3D parts are printed along a different axis, the terms “above”, “below”, “top”, “bottom”, and the like are relative to the given axis.

The term “electrostatography” refers to the formation and utilization of latent electrostatic charge patterns to form an image of a layer of a part, a support structure or both on a surface. Electrostatography includes, but is not limited to, electrophotography where optical energy is used to form the latent image, ionography where ions are used to form the latent image and/or electron beam imaging where electrons are used to form the latent image.

The term “providing”, such as for “providing a material” and the like, when recited in the claims, is not intended to require any particular delivery or receipt of the provided item. Rather, the term “providing” is merely used to recite items that will be referred to in subsequent elements of the claim(s), for purposes of clarity and ease of readability.

The terms “about” and “substantially” are used herein with respect to measurable values and ranges due to expected variations known to those skilled in the art (e.g., limitations and variabilities in measurements).

This summary is an overview of some of the teachings of the present application and is not intended to be an exclusive or exhaustive treatment of the present subject matter. Further details are found in the detailed description and appended claims. Other aspects will be apparent to persons skilled in the art upon reading and understanding the following detailed description and viewing the drawings that form a part thereof, each of which is not to be taken in a limiting sense. The scope herein is defined by the appended claims and their legal equivalents.

### BRIEF DESCRIPTION OF THE FIGURES

Aspects may be more completely understood in connection with the following figures (FIGS.), in which:

FIG. 1 is a schematic diagram of an additive manufacturing system in accordance with an embodiment of the present disclosure.

FIG. 2 is a schematic cross sectional diagram of two spherical parts contained within a rectangular region of support material, after deposition.

FIG. 3 is a schematic cross sectional diagram of two spherical parts contained within separate regions of support material, including regions of a skin formed by the support region along the upper half of the spherical parts.

FIG. 4 is a schematic cross sectional diagram of two spherical parts contained within separate regions of support material, including regions of a skin formed by the support region along the upper half of the spherical parts along with a further region of part material in a supporting role.

FIG. 5 is a schematic cross sectional diagram of two spherical parts contained within separate regions of support material, including regions of a skin formed by the support region along the lower region of support including a lattice of part material.

FIG. 6 is a schematic cross sectional diagram of two spherical parts contained within separate regions of support material, including regions of support material using a drafted construction.

While embodiments are susceptible to various modifications and alternative forms, specifics thereof have been shown by way of example and drawings, and will be described in detail. It should be understood, however, that the scope herein is not limited to the particular aspects described. On the contrary, the intention is to cover modifications, equivalents, and alternatives falling within the spirit and scope herein.

### DETAILED DESCRIPTION

The present disclosure is directed, generally, to methods of practicing STEP printing processes so as to reduce the amount of support material that is used. Generally such methods involve reducing the amount of support material and replacing it with material-free areas, such as by increasing non-printed “air” voxels. Thus, in some embodiments support voxels are replaced with air voxels, starting at the top surface of the bounding box defining the model (or part), and stopping at the first part voxel for each (x,y) location. The reductions in support material are made in a controlled manner to preserve the overall quality of the printed part.

In a further example embodiment, it is possible to replace some of the support material with part material, which can be desirable in implementations where the part material is less expensive than the support material, or where the part material is more readily reused than the support material. In such constructions a sparse lattice of part voxels replaces support voxels away from part surfaces for added strength and reduced cost. In such embodiments the part voxels are intermixed with support voxels, and optionally air voxels, to reduce cost while retaining performance and part quality of the printed part. Thus in these implementations some part material is deposited in a traditional sense to form the part being produced, while other part material is deposited in the volume normally occupied by support material, and this latter part material is removed along with the support material during post-print processing.

In a further example implementations, a sparse lattice of model material in the remaining support volume is used to reduce support flow and further reduce support consumption. In these implementations, a portion of the support material is replaced with part material in regions that do not form the finished part. The part material deposited into the support material is typically deposited in a manner that it does not significantly impede the removal of support material, and also does not have structural integrity that would prevent it removal after dissolving the support material.

Further, in some implementations it is possible to draft the support vertical walls outwards to the extent that the support material will tolerate shelving, in other words it is possible to have support layers extend outward as they are built upward, thereby reducing the total amount of support material that is used.

In all such constructions, particular care is generally given to the surface that will form the exterior of the finished part (i.e., the surface of the finished part). In this construction careful design and deposition of the layers of part material voxels, support material voxels, and air voxels is necessary, and typically includes providing more support material adjacent to the part surface than away from the part surface. Thus, a “skin” of support material can be printed immediately adjacent to the part material, along then methods of reducing support material further away from the surface of the part. These methods retain part surface quality while reducing support material. Thus, in an example implementation, air voxels adjacent to the upward facing part surfaces are replaced with support voxels to a distance of 0.5 to 2.5 mm in x, y coordinates (and from 0.1 to 0.5 mm in z) forming a support skin, to maintain feature detail and geometric accuracy of the upward facing part surfaces. It is also possible to further replace air voxels adjacent in x, y coordinates to the support skin with part voxels to a distance of 0.1 to 1.0 mm, forming a boundary (also referred to as a dike) to constrain the flow of the support material so that the flow of part material provides surface-smoothing at the part-support interface.

Also, it will be appreciated that these various techniques can, and often are, combined together. For example, it is possible to create a skin of support material around the part surface, while also printing a lattice of part and support material away from the part surface. In the alternative, it is possible to use both a combination of part lattice and air voxels to reduce the amount of support material. Similarly, these techniques can be combined with drafting of the support layers (whether they be entirely support material, or support material combined with part material and/or air voxels).

The present disclosure is beneficial because a typical part produced using additive manufacturing might occupy 5% of the voxels of its bounding box (the bounding box generally being the overall rectangular box retaining the part or parts on the printing platen). Printing a solid cuboid brick of model and support materials to produce this part, for example, could in some implementations consume part times more support than part itself if the bounding box is quite large. Such situations would arise when a relatively small cuboid brick is formed on a relatively large platen. It is generally beneficial to produce parts in this brick-style, despite the large consumption of support material, because the build surface of the part is an unbroken rectangle, well supported underneath, with constant temperature and thermal conduction providing desirable mechanical and thermal production properties. Other benefits in the brick design include the required transfuse pressure is more constant in the x-y plane, the heating and cooling requirements are relatively constant in the y-x plane; and the brick is resistant to buckling and other mechanical distortions. Also, it takes no more time for the STEP process to print in a brick-style.

Roughly speaking, an example part occupying 5% of its bounding box will have 48% of its support volume above the part and 47% below. If one replaces mechanically and thermally unnecessary support voxels with air voxels, it can be possible to reduce the support consumption by a factor of as much as two in some constructions. More detailed studies, utilizing the STEP-specific methods described here, suggest that this form of partial-support (probably a better title than porous-support) gives about one-third reduction in support consumption, on average.

In some constructions a dike or boundary of part material is formed adjacent to the support skin, flow-to-centerline techniques in U.S. Patent Application No. 62/908,087 (incorporated by reference herein) can be used to smooth the part surface, for both upward and downward facing surfaces.

The transition from brick support to partial support can change post processing. For example, osculating spray of heated support removal solution is often used for removal approach for traditional brick build. Partial support techniques described herein, in particular with part lattices, can also be removed with heated immersion in ultrasonic tanks. In addition, in certain implementations it is possible to sequentially use more than one technique, such as first using osculating jets to remove brick support and a second using an ultrasonic immersion.

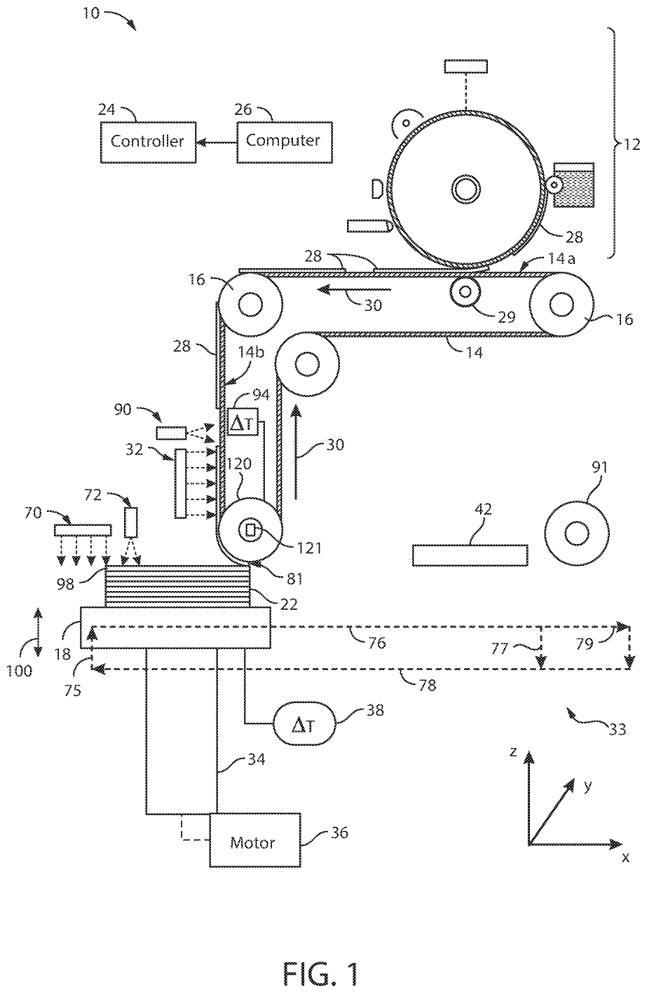

Now, in reference to the drawings, FIG. 1 provides a schematic diagram of an exemplary additive manufacturing system 10 for printing 3D parts and support structures in accordance with various embodiments. System 10 uses electrophotography to print successive layers of the 3D part and support structure.

In the embodiment shown, system 10 includes at least one EP engine 12 (and typically two or more EP engines that have different materials), a conveyor consisting of belt 14 and rollers 16, a build platform 18, a gantry 34, and belt-to-part transfer assembly 33 for printing 3D parts (e.g., 3D part 22) and any associated support structures (not shown). Examples of suitable components and functional operations for system 10 include those disclosed in U.S. Pat. Nos. 8,879,957 and 8,488,994, incorporated by reference in their entirety herein.

System 10 also includes controller 24, which is one or more control circuits, microprocessor-based engine control systems, and/or digitally-controlled imaging processor systems, and which is configured to operate the components of system 10 in a synchronized manner based on printing instructions received from host computer 26, including changing pressure applied to the top of parts. Host computer 26 is one or more computer-based systems configured to communicate with controller 24 to provide the print instructions (and other operating information). For example, host computer 26 may transfer information to controller 24 that relates to the sliced layers of 3D part 22 (and any support structures), thereby allowing system 10 to print 3D part 22 in a layer-by-layer manner.

The imaged layers 28 of the thermoplastic-based powder are then rotated to a first transfer region in which layers 28 are transferred from EP engine 12 to belt 14. Belt 14 is an example transfer medium or conveyor for transferring or otherwise conveying the imaged layers 28 from EP engine 12 to build platform 18 with the assistance of transfer roller 120. In the shown embodiment, belt 14 includes front or transfer surface 14a and rear or contact surface 14b, where front surface 14a faces EP engine 12. As discussed below, in some embodiments, belt 14 may be a multiple-layer belt with a low-surface-energy film that defines front surface 14a, and which is disposed over a base portion that defines rear surface 14b.

System 10 may also include biasing mechanism 29, which is configured to induce an electrical potential through the belt 14 to electrostatically attract part layers 28 of the thermoplastic-based powder from EP engine 12 to belt 14.

Rollers 16 are a series of drive and/or idler rollers or pulleys that are configured to maintain tension on belt 14 while belt 14 rotates in the rotational direction of arrows 30. System 10 may also include service loops (not shown), such as those disclosed in U.S. Pat. No. 8,488,994.

Belt 14 conveys successive layers 28 from EP engine 12 to belt-to-part transfer assembly 33, which transfers each part layer onto previously transferred layers of part 22 in a layer-by-layer manner. Belt-to-part transfer assembly 33 optionally includes a selective fusing heater 90, a layer transfer heater 32, a uniform part transfer heater, a selective part transfer heater 72, a nip or transfer roller 120, an air knife or air tunnel 42 and a cooling roller 91. However, other configurations of belt-to-part transfer assembly 33 are also contemplated.

Transfer of a next layer 28 onto a previously transferred layer 98 begins by heating the fully-supported layer 28 on belt 14 to near an intended transfer temperature using layer transfer heater 32 prior to reaching transfer roller 120. Examples of suitable devices for heater 32 include non-contact radiant heaters (e.g., infrared heaters or microwave heaters), convection heating devices (e.g., heated air blowers), contact heating devices (e.g., heated rollers and/or platens), combinations thereof, and the like, where non-contact radiant heaters are preferred. Each layer 28 desirably passes by (or through) heater 32 for a sufficient residence time to heat the layer 28 to the intended transfer temperature.

Additionally, platen gantry 34 moves build platform 18 along the positive z-axis in the direction of arrow 75 and then, along, or through uniform part transfer heater in the positive x direction of arrow 76. Gantry 34 is operated by a motor 36 based on commands from controller 24, where motor 36 may be an electrical motor, a hydraulic system, a pneumatic system, or the like. In the shown embodiments, build platform 18 is heatable with heating element 38 (e.g., an electric heater). Heating element 38 is configured to heat and maintain build platform 18 at an elevated temperature that is greater than room temperature (e.g., 25° C.), such as at the desired average part temperature of 3D part 22. This allows build platform 18 to assist in maintaining 3D part 22 at this average part temperature.

In further embodiments, the temperature of build platform 18 is the bulk temperature (near Tg, or 120 degrees Celsius for ABS) within about 100 mils of the build plane. As the part grows in Z, the build platform temperature drops linearly with Z, generating a constant low thermal gradient and heat flow in Z, at roughly 18 degrees Celsius/inch. This reduces the risk of narrow vertical structures (posts and beams) becoming unstable. The gentle cooling rate is not sufficient to create substantial curl, but is sufficient to make tall parts mechanically robust.

Heater 70 heats the top surface of previously transferred layer 98 to an elevated temperature, such as at the same transfer temperature as heated layer 28 (or other suitable elevated temperature). Examples of suitable devices for uniform part transfer heater include non-contact radiant heaters (e.g., infrared heaters or microwave heaters), convection heating devices (e.g., heated air blowers), contact heating devices (e.g., heated rollers and/or platens), combinations thereof, and the like, where non-contact radiant heaters are preferred.

Belt 14 then moves the heated layer 28 to a predetermined registration location 81, as shown. The z position of build platform 18 established by moving the build platform 18 in the positive z direction of arrow 75 causes a pressure to be applied to heated layer 28 as belt 14 moves heated layer 28 between transfer roller 120 and build platform 18 or part 22. The pressure on heated layer 28 is desirably high enough to transfer heated layer 28 to the previously-transferred layer 98 of part 22 (or to build platform 18). However, the pressure is also desirably balanced, including as described herein to maintain substantially constant pressure during a transfuse cycle, to prevent compressing 3D part 22 too much, thereby allowing 3D part 22 to maintain its dimensional integrity. As described herein, variation of the pressure can be based upon the part being printed (part vs. support material; part density, material properties, nip roller properties, etc.)

While build platform 18 remains engaged with belt 14, gantry 34 moves build platform 18 (and 3D part 22) along the x-axis in the direction of arrow 76, at a rate that is synchronized with the rotational rate of belt 14 in the direction of belt 14 at the bottom of transfer roller 120. This presses the belt 14 and the heated layer 28 between the top layer 98 of 3D part 22 and transfer roller 120. Due to the heat and pressure, pressed layer 28 separates and disengages from belt 14 and transfers to top layer 98 of 3D part 22 at transfer roller 120.

Gantry 34 then moves transferred layer 28 past an air tunnel 42, such as an air knife or air tunnel 42, which cools the top exposed surface of the transferred layers to cool part 22. Gantry 34 then drops build platform 18 down along path 77, before moving build platform 18 in the negative x direction along path 78. The process is then repeated for the next layer.

During a transfusion process, when an image layer 28 is transferred to a build platform 18, the image layer 28 and build platform 18 make contact at a registration location 81, which is also a transfer or transfuse roller 120 nip point. Transfuse roller 120 may be considered to be a nip roller which may be an exemplary heatable element or heatable layer transfusion element, which is configured to rotate around a fixed axis with the movement of the belt 14. In the shown embodiment, the nip roller is heatable with an optional heating element 94 (e.g., an electric heater). The heating element 94 is configured to heat and maintain nip roller at an elevated temperature that is greater than room temperature (25° C.), such as at a desired transfer temperature for the image layers 28.

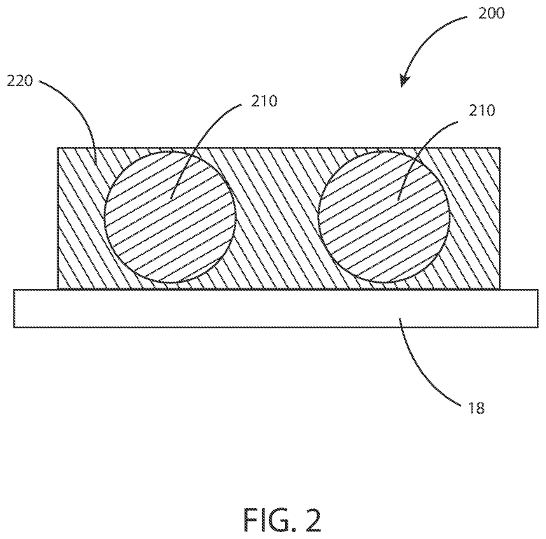

FIG. 2 is a schematic cross sectional diagram of a platen 18 with a combined printed region 200 containing two spherical parts 210 formed within a rectangular region of support material 220 (a “brick”). In this convention construction the entirely of the spherical parts 210 is surrounded by a continuous and relatively homogenous mass of support material 220. As addressed above, such constructions produce quality parts but can be inefficient in use of support material

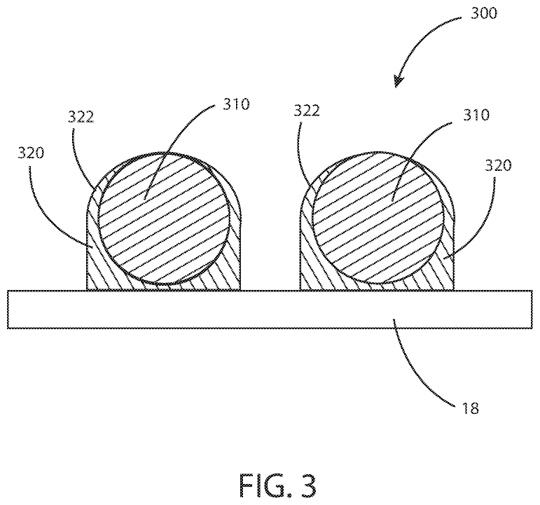

FIG. 3 is a schematic cross sectional diagram of platen 18 with a combined printed region 300 having two spherical parts 310 contained within separate regions of support material 320, including regions of a support skin 322 forming a support region along the upper half of the spherical parts 310. The support skin 322 helps form a smooth surface for the spherical parts 310, while also providing some limited mechanical support.

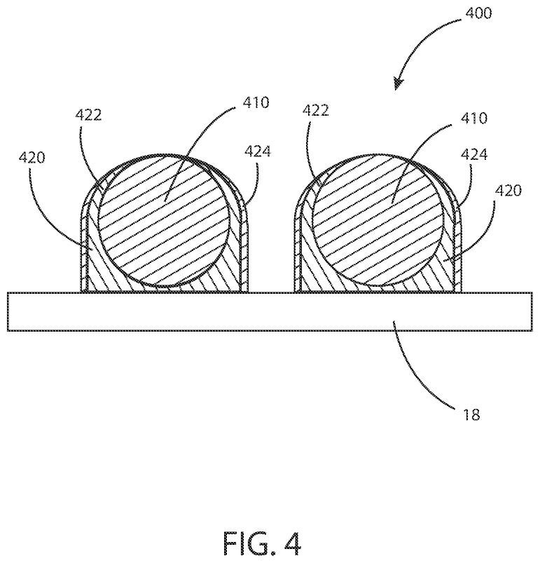

FIG. 4 is a schematic cross sectional diagram of platen 18 with a combined printed region 400 having two spherical parts 410 contained within separate regions of support material 420, including regions of a support skin 422 forming a support region along the upper half of the spherical parts 410. The support skin 422 and part material 424 overlying int help form a smooth surface for the spherical parts 410, while also providing some limited mechanical support.

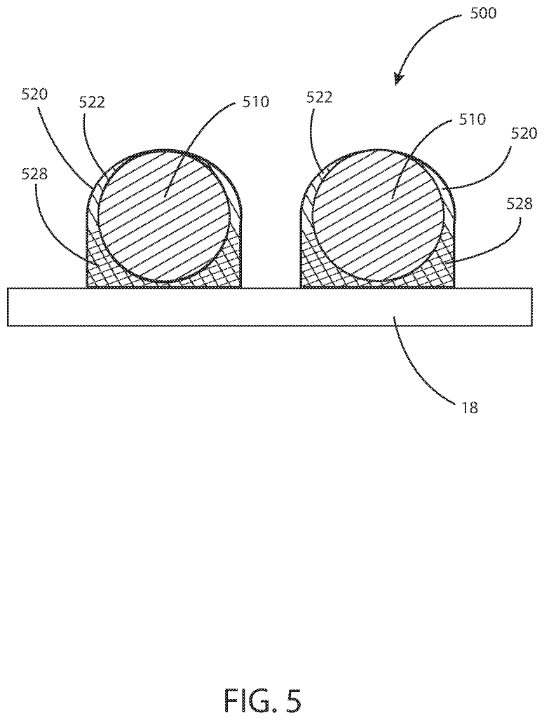

FIG. 5 is a schematic cross sectional diagram of combined printed region 500 with two spherical parts 510 contained within separate regions of support material 520, including regions of a support skin 522 forming a support region along the upper half of the spherical parts 510. The support skin 522 helps form a smooth surface for the spherical parts 510, while also providing some limited mechanical support. In addition, a lattice 528 of support material is used, forming a portion of the support.

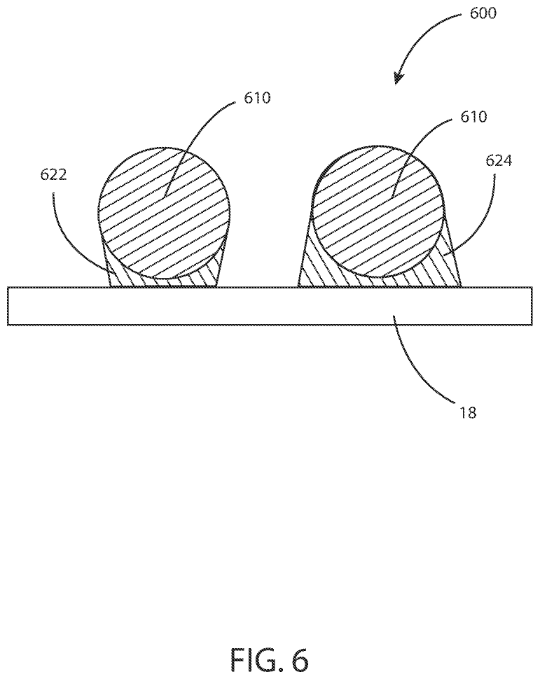

FIG. 6 is a schematic cross sectional diagram of build platform 18 (also called platen 18) with a combined printed region 600 having two spherical parts 610 contained within separate regions of support material region 622 and support material region 624 with schematic cross sectional diagram of two spherical parts 610 contained within separate regions of support material. Support material region 622 drafts upward and outward, providing for a significant reduction in support material; while support material region 624 drafts upward and inward, also providing a reduction in support material but less than the configuration with support material region 622.

Directional orientations such as “above”, “below”, “top”, “bottom”, and the like are made with reference to a direction along a printing axis of a 3D part. In the embodiments in which the printing axis is a vertical z-axis, the layer-printing direction is the upward direction along the vertical z-axis. In these embodiments, the terms “above”, “below”, “top”, “bottom”, and the like are based on the vertical z-axis. However, in embodiments in which the layers of 3D parts are printed along a different axis, the terms “above”, “below”, “top”, “bottom”, and the like are relative to the given axis.

The term “electrostatography” refers to the formation and utilization of latent electrostatic charge patterns to form an image of a layer of a part, a support structure or both on a surface. Electrostatography includes, but is not limited to, electrophotography where optical energy is used to form the latent image, ionography where ions are used to form the latent image and/or electron beam imaging where electrons are used to form the latent image.

It should be noted that, as used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise.

It should also be noted that, as used in this specification and the appended claims, the phrase “configured” describes a system, apparatus, or other structure that is constructed or configured to perform a particular task or adopt a particular configuration. The phrase “configured” can be used interchangeably with other similar phrases such as arranged and configured, constructed and arranged, constructed, manufactured and arranged, and the like.

All publications and patent applications in this specification are indicative of the level of ordinary skill in the art to which this invention pertains. All publications and patent applications are herein incorporated by reference to the same extent as if each individual publication or patent application was specifically and individually indicated by reference.

As used herein, the recitation of numerical ranges by endpoints shall include all numbers subsumed within that range (e.g., 2 to 8 includes 2.1, 2.8, 5.3, 7, etc.).

The headings used herein are provided for consistency with suggestions under 37 CFR 1.77 or otherwise to provide organizational cues. These headings shall not be viewed to limit or characterize the invention(s) set out in any claims that may issue from this disclosure. As an example, although the headings refer to a “Field,” such claims should not be limited by the language chosen under this heading to describe the so-called technical field. Further, a description of a technology in the “Background” is not an admission that technology is prior art to any invention(s) in this disclosure. Neither is the “Summary” to be considered as a characterization of the invention(s) set forth in issued claims.

The embodiments described herein are not intended to be exhaustive or to limit the invention to the precise forms disclosed in the following detailed description. Rather, the embodiments are chosen and described so that others skilled in the art can appreciate and understand the principles and practices. As such, aspects have been described with reference to various specific and preferred embodiments and techniques. However, it should be understood that many variations and modifications may be made while remaining within the spirit and scope herein.

1. A method of printing a part in an additive manufacturing system, comprising:
electrostatographically developing a layer of a part material;
electrostatographically developing a layer of a support material; and
stacking and bonding the layers of support material and the layers of part material to form a three-dimensional part within a bounding box, wherein the support material is configured to form a support skin around an upward-facing surface of the three-dimensional part and within the part bounding box.

2. The method of any of claims 1 and 3-12, wherein the support skin has a thickness of 0.5 to 2.5 mm.

3. The method of any of claims 1-2 and 4-12, further comprising forming a boundary layer around the support skin.

4. The method of any of claims 1-3 and 4-12, wherein the boundary layer comprises part material.

5. The method of any of claims 1-4 and 6-12, wherein the boundary layer has a thickness of 0.5 to 2.5 mm.

6. The method of any of claims 1-5 and 7-12, wherein the boundary layer forms a boundary to constrain the flow of the support material.

7. The method of any of claims 1-6 and 8-12, wherein the boundary layer is of sufficient strength to resist deformation of the support structure during printing of a layer of the part.

8. The method of any of claims 1-7 and 9-12, wherein the layer of support material comprises a lattice of support voxels and a lattice of part material voxels.

9. The method of any of claims 1-8 and 10-12, wherein the part material voxels do not make contact with the three-dimensional part.

10. The method of any of claims 1-9 and 11-12, wherein the layer of support material comprises a lattice of support voxels and a lattice of air voxels.

11. The method of any of claims 1-10 and 12, further comprising, drafting the support vertical walls outwards as the layers increase in the z-axis.

12. The method of any of claims 1-11, wherein the porosity of support material increases in with distance from part material.

13. A method of printing a part in an additive manufacturing system, comprising:
electrostatographically developing a layer of a part material; and
electrostatographically developing a layer of a support material, wherein the layer of support material comprises a lower concentration of support material distal to the interface between the part material and support material.

14. The method of any of claims 13 and 15-25, further comprising a support skin, wherein the support skin has a thickness of 0.5 to 2.5 mm normal to the part surface.

15. The method of any of claims 13-14 and 16-25, further comprising a dike comprising a support material forming a boundary layer around the support skin.

16. The method of any of claims 13-15 and 17-25, wherein the boundary layer comprises of part material.

17. The method of any of claims 13-16 and 18-25, wherein the boundary layer has a thickness of 0.5 to 2.5 mm.

18. The method of any of claims 13-17 and 19-25, wherein the boundary layer forms a boundary to constrain the flow of the support material.

19. The method of any of claims 13-18 and 20-25, wherein the boundary layer is of sufficient strength to resist deformation of the support structure during printing of a layer of the part.

20. The method of any of claims 13-19 and 21-25, wherein the layer of support material comprises a lattice of support voxels and a lattice of part material voxels.

21. The method of any of claims 13-20 and 22-25, wherein the part material voxels do not make contact with the three-dimensional part.

22. The method of any of claims 13-21 and 23-25, wherein the layer of support material comprises a lattice of support voxels and a lattice of air voxels.

23. The method of any of claims 13-22 and 24-25, further comprising, drafting the support vertical walls outwards as the layers increase in the z-axis.

24. The method of any of claims 13-23 and 25, wherein the porosity of support material increases in with distance from part material.

25. The method of any of claims 13-24, whereby the volume of support material in the completed assembly is less than 80% of the support volume required to solidly print the bounding box’
